(19) United States
(12) Patent Application Publication
(10) Pub. No.: US 2016/0007148 A1
(43) Pub. Date: Jan. 7, 2016

(54) ELECTRONIC DEVICE AND METHOD OF DISPLAYING SITUATION INFORMATION

(71) Applicant: Samsung Electronics Co., Ltd., Gyeonggi-do (KR)

(72) Inventors: Sang-Mi KIM, Gyeonggi-do (KR); Mu-Woong LEE, Gyeonggi-do (KR); Yoon-Kyong LEE, Seoul (KR); Jae-Won LEE, Gyeonggi-do (KR); Seok-Jin CHANG, Gyeonggi-do (KR); Brian CHO, Gyeonggi-do (KR); Dong-Hyun ROH, Gyeonggi-do (KR)

(21) Appl. No.: 14/754,876

(22) Filed: Jun. 30, 2015

(30) Foreign Application Priority Data
Jul. 1, 2014 (KR) 10-2014-0081831

(51) Int. Cl. H04W 4/02

(52) U.S. Cl. CPC H04W 4/02

(57) ABSTRACT

Disclosed is a method of operating an electronic device. The electronic device includes a display and a processor, which is configured to execute the method including identifying a current position of the electronic device, detecting one or more preset electronic devices based on the identified current position, and displaying the one or more preset electronic devices.

### CLAIM OF PRIORITY

This application claims priority under 35 U.S.C. §119(a) to Korean Application Serial No. 10-2014-0081831, which was filed in the Korean Intellectual Property Office on Jul. 1, 2014, the entire content of which is hereby incorporated by reference.

### TECHNICAL FIELD

The present disclosure relates to an electronic device and a method for displaying situation information.

### BACKGROUND

According to the development of functions of electronic devices, the electronic devices may share position information with other electronic devices by using various sensors included in the electronic devices. For example, the electronic device may identify a current position by using GPS (Global Positioning Satellite), AP (Access Point), and WiFi (wireless local area network). In addition, the electronic device may identify a position of another electronic device.

Accordingly, accessibility between electronic devices is improved.

As position information of the electronic device is known to users of other electronic devices, personal information is easily exposed to other users. For example, when a user of an electronic device desires to acquire position information of another user, the user should also provide its own position information to the other user, so that it is difficult to protect the personal information.

### SUMMARY

Various embodiments of the present disclosure may provide an apparatus and a method for enhancing the protection of personal information of a user since the user can selectively configure contacts from which the user desires to acquire situation information among the contacts stored in the electronic device and thus the personal information is not exposed to all users having other contacts.

Various embodiments of the present disclosure may provide an apparatus and a method for further enhancing the protection of personal information since the electronic device provides only information indicating that an electronic device is located within a preset range to a user configured by a user's selection without providing detailed position information.

Various embodiments of the present disclosure may provide an apparatus and a method for increasing the user convenience since a process of configuring situation information may be performed not only through an independent method but also while interworking with a pre-stored application or system.

Various embodiments of the present disclosure may provide an apparatus and a method for reducing battery consumption of the electronic device and thus increasing economic feasibility since the electronic device may use adjacent AP information of the electronic device when acquiring current position information of the electronic device.

In accordance with an aspect of the present disclosure, a method of operating an electronic device is provided. The method includes: identifying a current position of the electronic device, detecting one or more preset electronic devices based on the identified current position, and displaying the one or more preset electronic devices.

In accordance with another aspect of the present disclosure, a system is provided. The electronic device includes: a display, and a processor configured to: identify a current position of the electronic device, detect one or more preset electronic devices based on the identified current position, and displaying on the display the one or more preset electronic devices.

According to various embodiments of the present disclosure, a user can selectively configure contacts from which the user desires to acquire situation information among the contacts stored in an electronic device, so that personal information is not exposed to all users having other contacts and thus the protection of the personal information of the user can be enhanced.

### BRIEF DESCRIPTION OF THE DRAWINGS

The present disclosure will be more apparent from the following detailed description taken in conjunction with the accompanying drawings, in which:

FIG. 1 illustrates a network environment 100 including an electronic device 101 according to various embodiments;

FIG. 2 is a block diagram of hardware according to an embodiment of the present disclosure;

FIG. 3 is a general block diagram of an electronic device according to various embodiments;

FIG. 4 is a block diagram illustrating a configuration of a server according to various embodiments;

FIG. 5A and FIG. 5B illustrate a view for configuring publication configuration information according to various embodiments;

FIG. 6 illustrates a view for searching for an adjacently located AP and recognizing another user located within a preset range according to various embodiments;

FIG. 7 is a view illustrating a screen on which an electronic device receives situation information from a server according to various embodiments;

FIG. 8 is a view illustrating a screen for receiving situation information while interworking with a chat application according to various embodiments;

FIG. 9 is a flowchart illustrating a sequence of an operation of an electronic device according to various embodiments;

FIG. 10 is a flowchart illustrating a sequence of an operation of a server according to various embodiments; and

FIG. 11 is a view illustrating reception of situation information by using AP information according to various embodiments of the present disclosure.

### DETAILED DESCRIPTION

Hereinafter, the present disclosure will be described with reference to the accompanying drawings. The present disclosure may have various embodiments, and modifications and changes may be made therein. Therefore, the present disclosure will be described in conjunction with particular embodiments shown in the accompanying drawings. However, it should be understood that there is no intent to limit the present disclosure to the particular forms disclosed herein; rather, the present disclosure should be construed to cover all modifications, equivalents, and/or alternatives falling within the disclosure. In the description of the drawings, identical or similar reference numerals are used to designate identical or similar elements.

In the present disclosure, the expression “include” or “may include” refers to existence of a corresponding function, operation, or element, and does not limit one or more additional functions, operations, or elements. In the present disclosure, the terms such as “include” and/or “have” may be construed to denote a certain characteristic, number, step, operation, constituent element, element or a combination thereof, but may not be construed to exclude the existence of or a possibility of addition of one or more other characteristics, numbers, steps, operations, constituent elements, elements or combinations thereof.

In the present disclosure, the expression “or” includes any or all combinations of words enumerated together. For example, the expression “A or B” may include A, may include B, or may include both A and B.

In the present disclosure, expressions including ordinal numbers, such as “first” and “second,” etc., may modify various elements. However, such elements are not limited by the above expressions. For example, the above expressions do not limit the sequence and/or importance of the elements. The above expressions are used merely for the purpose of distinguishing an element from the other elements. For example, a first user device and a second user device indicate different user devices although both of them are user devices. For example, a first element could be termed a second element, and similarly, a second element could be also termed a first element without departing from the present disclosure.

In the case where an element is referred to as being “connected” or “accessed” to other elements, it should be understood that not only the element is directly connected or accessed to the other elements, but also another element may exist between them. Meanwhile, in the case where an element is referred to as being “directly connected to” or “directly accessing” other elements, it should be understood that there is no element therebetween.

The terms used in the present disclosure are only used to describe specific embodiments, and are not intended to limit the present disclosure. As used herein, the singular forms are intended to include the plural forms as well, unless the context clearly indicates otherwise.

Unless defined otherwise, all terms used herein, including technical and scientific terms, have the same meaning as commonly understood by those of skill in the art to which the present disclosure pertains. Such terms as those defined in a generally used dictionary are to be interpreted to have the meaning equal to the contextual meaning in the relevant field of art, and are not to be interpreted to have ideal or excessively formal meaning unless clearly defined in the present disclosure.

An electronic device according to the present disclosure may be a device including a communication function. For example, the electronic device may include at least one of a smart phone, a tablet Personal Computer (PC), a mobile phone, a video phone, an e-book reader, a desktop PC, a laptop PC, a netbook computer, a PDA, a Portable Multimedia Player (PMP), an MP3 player, a mobile medical device, a camera, a wearable device (for example, a Head-Mounted-Device (HMD) such as electronic glasses, electronic clothes, an electronic bracelet, an electronic necklace, an electronic appcessory, an electronic tattoo, or a smart watch.

According to some embodiments, the electronic device may be a smart home appliance with a communication function. The smart home appliance as an example of the electronic device may include at least one of, for example, a television, a Digital Video Disk (DVD) player, an audio, a refrigerator, an air conditioner, a vacuum cleaner, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, or an electronic picture frame.

According to some embodiments, the electronic device may include at least one of various medical appliances (e.g., magnetic resonance angiography (MRA), magnetic resonance imaging (MRI), computed tomography (CT), and ultrasonic machines), navigation equipment, a global positioning system (GPS) receiver, an event data recorder (EDR), a flight data recorder (FDR), automotive infotainment device, electronic equipment for ships (e.g., ship navigation equipment and a gyrocompass), avionics, security equipment, a vehicle head unit, an industrial or home robot, an automatic teller machine (ATM) of a banking system, or a point of sales (POS) of a shop.

According to some embodiments, the electronic device may include at least one of a part of furniture or a building/structure having a communication function, an electronic board, an electronic signature receiving device, a projector, or various kinds of measuring instruments (e.g., a water meter, an electric meter, a gas meter, a radio wave meter, and the like). The electronic device according to the present disclosure may be a combination of one or more of the aforementioned various devices. Also, the electronic device according to the present disclosure may be a flexible device. Further, it is obvious to those skilled in the art that the electronic device according to the present disclosure is not limited to the aforementioned devices.

Hereinafter, an electronic device according to various embodiments of the present disclosure will be described with reference to the accompanying drawings. The term “user” as used in various embodiments of the present disclosure may indicate a person who uses an electronic device or a device (e.g., artificial intelligence electronic device) that uses an electronic device.

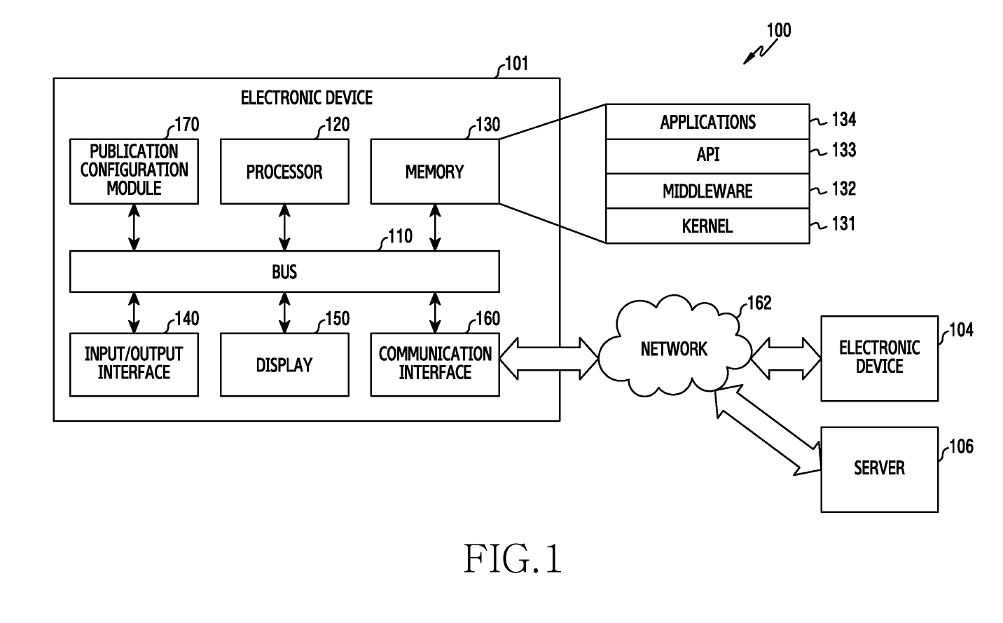

FIG. 1 illustrates a network environment 100 including an electronic device 101 according to various embodiments. Referring to FIG. 1, the electronic device 101 may include a bus 110, a processor 120, a memory 130, an input/output interface 140, a display 150, a communication interface 160, a publication configuration module 170, and a content detection module 180.

The bus 110 may be a circuit for connecting the aforementioned components and transmitting communication (for example, a control message) between the aforementioned components.

For example, the processor 120 may receive instructions from the aforementioned other elements (for example, the memory 130, the input/output interface 140, the display, the communication interface 160, and the publication configuration module 170) through the bus 110, decipher the received instructions, and perform calculation or data processing according to the deciphered instructions.

The memory 130 may store instructions or data received from or created by the processor 120 or other elements (for example, the input/output interface 140, the display, the communication interface 160, and the publication configuration module 170). The memory 130 may include programming modules, for example, a kernel 131, middleware 132, an Application Programming Interface (API) 133, and applications 134. Each of the aforementioned programming modules may be formed of software, firmware, hardware, or a combination of at least two thereof.

The kernel 131 may control or manage system resources (for example, the bus 110, the processor 120, the memory 130, or the like.) used to execute operations or functions implemented by other programming modules (for example, the middleware 132, the API 133, and the applications 134). In addition, the kernel 131 may provide an interface through which the middleware 132, the API 133, or the applications 134 may control or manage the individual components of the electronic device 101 while accessing the individual components.

The middleware 132 may perform a relay function of allowing the API 133 or the application 134 to communicate with the kernel 131 to exchange data therewith. Furthermore, with regard to task requests received from the applications 134, the middleware 132 may perform a control (for example, scheduling or load balancing) for the task requests, using a method of allocating a priority to at least one of the applications 134 so that the application having the priority can first use the system resources (for example, the bus 110, the processor 120, and the memory 130) of the electronic device 101.

The API 133 is an interface through which the applications 134 may control functions provided by the kernel 131 and the middleware 132, and may include at least one interface or function (for example, instruction) for file control, window control, image processing, or text control.

According to various embodiments, the applications 134 may include a Short Message Service (SMS)/Multimedia Messaging Service (MMS) application, an email application, a calendar application, an alarm application, a health care application (for example, an application measuring a quantity of exercise or blood sugar) or an environmental information application (for example, an application providing information on air pressure, humidity or temperature). Additionally or alternately, the applications 134 may include an application related to an information exchange between the electronic device 101 and an external electronic device (for example, an electronic device 104). The application related to the exchange of information may include, for example, a notification relay application for transferring predetermined information to the external electronic device or a device management application for managing the external electronic device.

For example, the notification relay application may include a function of transferring, to the external electronic device (for example, the electronic device 104), notification information generated from other applications of the electronic device 101 (for example, an SMS/MMS application, an e-mail application, a health management application, an environmental information application, and the like). Additionally or alternatively, the notification relay application may receive notification information from, for example, the external electronic device (for example, the electronic device 104) and provide the received notification information to a user. For example, the device management application may manage (for example, install, delete, or update) functions for at least a part of the external electronic device (for example, the electronic device 104) communicating with the electronic device 101 (for example, turning on/off the external electronic device itself (or some elements thereof) or adjusting brightness (or resolution) of a display), applications operating in the external electronic device, or services (for example, a telephone call service or a message service) provided from the external electronic device.

According to various embodiments, the applications 134 may include an application set on the basis of an attribute (for example, the type of electronic device) of the external electronic device (for example, the electronic device 104). For example, when the external electronic device is an MP3 player, the applications 134 may include an application related to the reproduction of music. Similarly, when the external electronic device is a mobile medical device, the applications 134 may include an application related to health care. According to an embodiment, the applications 134 may include at least one of an application designated to the electronic device 101 or an application received from the external electronic device (for example, a server 106 or the electronic device 104).

The input/output interface 140 may transfer instructions or data input from a user through an input/output device (for example, the sensor, a keyboard, or a touch screen) to, for example, the processor 120, the memory 130, the communication interface 160, or the publication configuration module 170 through the bus 110. For example, the input/output interface 140 may provide the processor 120 with data for a user's touch input through the touch screen. Furthermore, through the input/output device (for example, a speaker or a display), the input/output interface 140 may output instructions or data received from the processor 120, the memory 130, the communication interface 160, or the publication configuration module 170 through the bus 110. For example, the input/output interface 140 may output voice data, which is processed through the processor 120, to a user through a speaker.

The display 150 may display various pieces of information (for example, multimedia data or text data) for the user.

The communication interface 160 may connect communication between the electronic device 101 and the external electronic device (for example, the electronic device 104 or the server 106). For example, the communication interface 160 may be connected to a network 162 through wireless or wired communication to communicate with the external device. The wireless communication may include at least one of, for example, Wi-Fi, Bluetooth (BT), Near Field Communication (NFC), a Global Positioning System (GPS), and cellular communication (for example, Long Term Evolution (LTE), Long Term Evolution-Advanced (LTE-A), Code Division Multiple Access (CDMA), Wideband CDMA (WCDMA), Universal Mobile Telecommunication System (UMTS), Wireless Broadband (WiBro), or Global System for Mobile communication (GSM)). The wired communication may include at least one of, for example, a Universal Serial Bus (USB), a High Definition Multimedia Interface (HDMI), Recommended Standard 232 (RS-232), or a Plain Old Telephone Service (POTS).

According to an embodiment, the network 162 may be a communication network. The telecommunication network may include at least one of a computer network, Internet, Internet of things, or a telephone network. According to an embodiment, a protocol (for example, a transport layer protocol, data link layer protocol, or a physical layer protocol) for communication between the electronic device 101 and the external device may be supported by at least one of the application 134, the application programming interface 133, the middleware 132, the kernel 131, or the communication interface 160.

The publication configuration module 170 may configure the contact of an electronic device, with which the publication configuration module 170 will share situation information, among the contacts stored in the address book, and configure whether to share the situation information with the electronic device having the contact.

The content detection module 180 may process at least some pieces of information acquired from other components (for example, the processor 120, the memory 130, the input/output interface 140, the communication interface 160, or the publication configuration module 170), and may provide the processed information to the user through various methods. For example, the content detection module 180 may detect contents for the image generated by the publication configuration module 170, sets a recognition area for detecting the contents, stores information on the recognition area in the memory 130, and provide information on the detected contents to the user through the input/output interface 140.

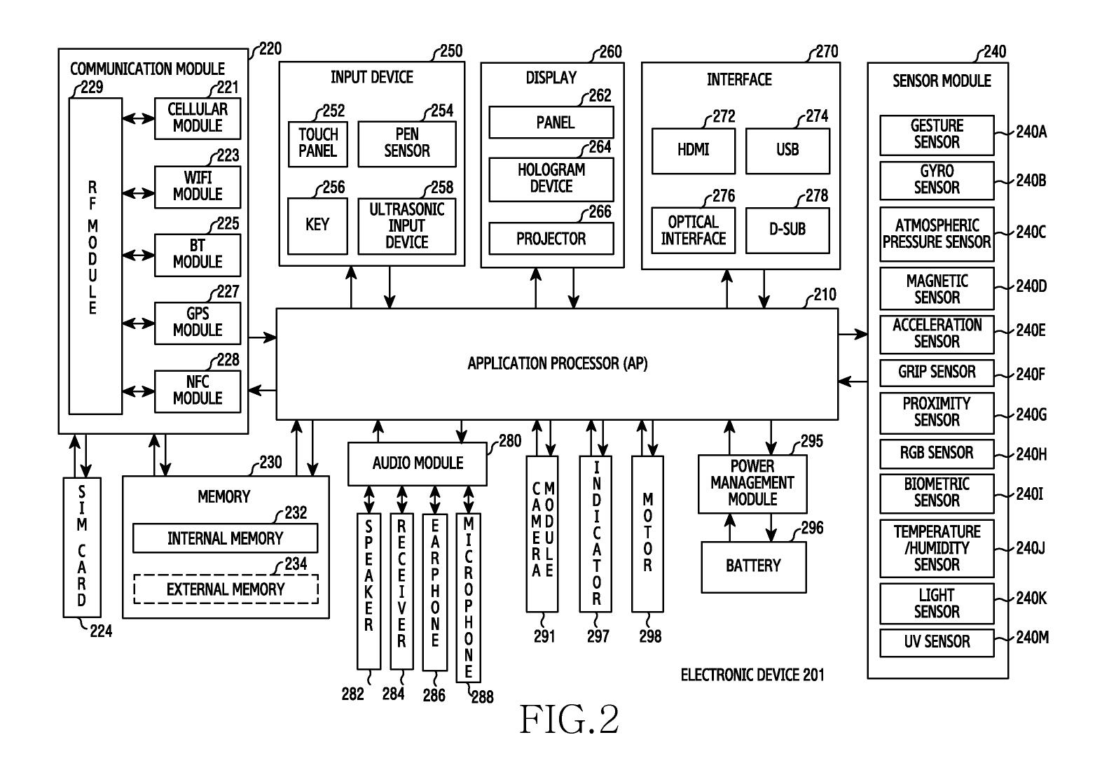

FIG. 2 is a block diagram of hardware according to an embodiment of the present disclosure. The electronic device 201 may, for example, include all or a part of the electronic device 101 shown in FIG. 1. The electronic device 201 may include at least one Application Processor (AP) 210, a communication module 220, a Subscriber Identifier Module (SIM) card 224, a memory 230, a sensor module 240, an input device 250, a display 260, an interface 270, an audio module 280, a camera module 291, a power management module 295, a battery 296, an indicator 297, or a motor 298.

The AP 210 may control a plurality of hardware or software components connected to the AP 210 by driving an operating system or an application program and perform processing of various pieces of data including multimedia data and calculations. The AP 210 may be implemented by, for example, a System on Chip (SoC). According to an embodiment, the AP 210 may further include a graphic processing unit (GPU) (not illustrated). According to various embodiments of the present disclosure, the AP 210 may configure publication configuration information with respect to contacts selected by the user. Further, the AP 210 may identify that situation information is configured to be shared with other electronic devices that have the selected contacts. In addition, the AP 210 may identify that the selected contact list includes an area for configuring the publication configuration information and identify that a configuration is made to share the situation information with other electronic devices having the contacts included in the contact list. Furthermore, the AP 210 may determine whether at least one piece of publication configuration information or position information has changed on a preset cycle.

The communication module 220 (for example, the communication interface 160) may perform data transmission/reception in communication between the electronic device 201 (for example, the electronic device 101) and other electronic devices (for example, the electronic device 104 or the server 106) connected thereto through a network. According to an embodiment, the communication module 220 may include a cellular module 221, a Wi-Fi module 223, a BT module 225, a GPS module 227, an NFC module 228, and a Radio Frequency (RF) module 229. According to various embodiments of the present disclosure, the communication module may transmit the configured publication configuration information and position information to the server, and receive situation information of one or more other electronic devices located with a predetermined range from the server. Further, when it is determined that at least one of the publication configuration information or the position information is changed, the communication module 220 may transmit the changed information to the server.

The cellular module 221 may provide a voice call, a video call, a text message service, or an Internet service through a communication network (for example, LTE, LTE-A, CDMA, WCDMA, UMTS, WiBro, or GSM). Further, the cellular module 221 may perform identification and authentication of electronic devices in a communication network using, for example, a subscriber identification module (for example, the SIM card 224). According to one embodiment, the cellular module 221 may perform at least some functions which can be provided by the AP 210. For example, the cellular module 221 may perform at least some of the multimedia control functions.

According to an embodiment, the cellular module 221 may include a communication processor (CP). Furthermore, the cellular module 221 may be implemented by, for example, an SoC. Although the components such as the memory 230 or the power management module 295 are illustrated as components separate from the AP 210, the AP 210 may be configured to include at least a few (for example, the cellular module 221) of the described components according to an embodiment.

According to an embodiment, the AP 210 or the cellular module 221 (for example, the CP) may load instructions or data received from at least one of a non-volatile memory and other components connected thereto into a volatile memory and process the loaded instructions or data. Furthermore, the AP 210 or the cellular module 221 may store data received from or generated by at least one of other elements in a non-volatile memory.

Each of the Wi-Fi module 223, the BT module 225, the GPS module 227, and the NFC module 228 may include, for example, a processor for processing data transmitted/received through the corresponding module. Although the cellular module 221, the WiFi module 223, the BT module 225, the GPS module 227, and the NFC module 228 are illustrated as separate blocks, at least some (for example, two or more) of the cellular module 221, the WiFi module 223, the BT module 225, the GPS module 227, and the NFC module 228 may be included in one Integrated Chip (IC) or one IC package. For example, at least some (for example, the communication processor corresponding to the cellular module 221 and the WiFi processor corresponding to the WiFi module 223) of the processors corresponding to the cellular module 221, the WiFi module 223, the BT module 225, the GPS module 227, and the NFC module 228 may be implemented as one SoC.

The RF module 229 may transmit/receive data, for example, an RF signal. Although not illustrated in the drawing, the RF module 229 may, for example, include a transceiver, a Power Amp Module (PAM), a frequency filter, a Low Noise Amplifier (LNA), or the like. Further, the RF module 229 may further include a component for transmitting/receiving electronic waves over a free air space in wireless communication, for example, a conductor, a conducting wire or the like. Although the cellular module 221, the Wi-Fi module 223, the BT module 225, the GPS module 227, and the NFC module 228 share one RF module 1229, at least one of the cellular module 221, the Wi-Fi module 223, the BT module 225, the GPS module 227, or the NFC module 228 may transmit/receive an RF signal through a separate RF module according to one embodiment.

The SIM cards 224 may be cards including a subscriber identification module and may be inserted into slots formed on a particular portion of the electronic device. The SIM card 224 may include unique identification information (for example, an Integrated Circuit Card IDentifier (ICCID)) or subscriber information (for example, International Mobile Subscriber Identity (IMSI)).

The memory 230 (for example, the memory 130) may include an internal memory 232 or an external memory 234. The internal memory 232 may include, for example, at least one of a volatile memory (for example, a Dynamic RAM (DRAM), a Static RAM (SRAM), and a Synchronous Dynamic RAM (SDRAM)), or a non-volatile Memory (for example, a One Time Programmable ROM (OTPROM), a Programmable ROM (PROM), an Erasable and Programmable ROM (EPROM), an Electrically Erasable and Programmable ROM (EEPROM), a mask ROM, a flash ROM, a NAND flash memory, and an NOR flash memory).

According to an embodiment, the internal memory 232 may be a Solid State Drive (SSD). The external memory 234 may further include a flash drive, for example, a Compact Flash (CF), a Secure Digital (SD), a Micro Secure Digital (Micro-SD), a Mini Secure Digital (Mini-SD), an extreme Digital (xD), a memory stick, or the like. The external memory 234 may be functionally connected with the electronic device 201 through various interfaces. According to an embodiment, the electronic device 201 may further include a storage device (or storage medium) such as a hard drive.

The sensor module 240 may measure a physical quantity or detect an operation state of the electronic device 201, and may convert the measured or detected information to an electrical signal. The sensor module 240 may include at least one of, for example, a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (for example, a Red/Green/Blue (RGB) sensor), a biometric sensor 240I, a temperature/humidity sensor 240J, an illumination sensor 240K, or an Ultra Violet (UV) sensor 240M. Additionally or alternatively, the sensor module 240 may include, for example, an E-nose sensor (not illustrated), an electromyography (EMG) sensor (not illustrated), an electroencephalogram (EEG) sensor (not illustrated), an electrocardiogram (ECG) sensor (not illustrated), an Infrared (IR) sensor (not illustrated), an iris sensor (not illustrated), and a fingerprint sensor (not illustrated). The sensor module 240 may further include a control circuit for controlling one or more sensors included in the sensor module 240.

The input device 250 may include a touch panel 252, a (digital) pen sensor 254, a key 256, or an ultrasonic input device 258. The touch panel 252 may recognize a touch input through at least one of, for example, a capacitive type, a resistive type, an infrared type, or an ultrasonic type. The touch panel 252 may further include a control circuit. A capacitive touch panel may recognize a physical contact or proximity. The touch panel 252 may further include a tactile layer. In this case, the touch panel 252 may provide a tactile reaction to the user. According to various embodiments of the present disclosure, the input device 250 may receive an input for execution of an application for configuring publication configuration information, display stored contacts, and receive a selection of at least one of the displayed contacts. Further, the input device 250 may display one or more contact lists including contact information of other electronic devices and receive a selection of one of the displayed one or more contact lists. In addition, the input device 250 may display information on one or more other electronic devices located within a preset range.

The (digital) pen sensor 254 may be implemented, for example, using the same or similar method to receiving a user's touch input or using a separate recognition sheet. The key 256 may include, for example, a physical button, an optical key, or a keypad. The ultrasonic input device 258 may identify data by detecting an acoustic wave with a microphone (for example, a microphone 288) of the electronic device 201 through an input unit generating an ultrasonic signal, and may perform wireless recognition. According to an embodiment, the electronic device 201 may also receive a user input from an external device (for example, a computer or a server) connected thereto by using the communication module 220.

The display 260 (for example, the display 150) may include a panel 262, a hologram device 264, or a projector 266. The panel 262 may be, for example, a Liquid Crystal Display (LCD), Active-Matrix Organic Light Emitting Diode (AM-OLED), or the like. The panel 262 may be implemented to be, for example, flexible, transparent, or wearable. The panel 262 may be configured as one module together with the touch panel 252. The hologram device 264 may show a stereoscopic image in the air using interference of light. The projector 266 may project light onto a screen to display an image. The screen may be located, for example, inside or outside the electronic device 201. According to an embodiment, the display 260 may further include a control circuit for controlling the panel 262, the hologram device 264, or the projector 266.

The interface 270 may include, for example, a High-Definition Multimedia Interface (HDMI) 272, a Universal Serial Bus (USB) 274, an optical interface 276, or a D-subminiature (D-sub) 278. The interface 270 may be included in, for example, the communication interface 160 illustrated in FIG. 1. Additionally or alternatively, the interface 270 may include, for example, a Mobile High-definition Link (MHL) interface, a Secure Digital (SD) card/Multi-Media Card (MMC) interface, or an Infrared Data Association (IrDA) standard interface.

The audio module 280 may bilaterally convert a sound and an electrical signal. At least some components of the audio module 280 may be included in, for example, the input/output interface 140 illustrated in FIG. 1. The audio module 280 may process sound information input or output through, for example, the speaker 282, the receiver 284, the earphones 286, the microphone 288 or the like.

The camera module 291 is a device for capturing a still image or a video, and according to an embodiment, may include one or more image sensors (for example, a front sensor or a rear sensor), a lens (not illustrated), an Image Signal Processor (ISP) (not illustrated), or a flash (not illustrated) (for example, an LED or xenon lamp).

The power management module 295 may manage power of the electronic device 201. Although not illustrated, the power management module 295 may include, for example, a Power Management Integrated Circuit (PMIC), a charger Integrated Circuit (IC), or a battery or fuel gauge.

The PMIC may be mounted to, for example, an integrated circuit or an SoC semiconductor. Charging methods may be classified into a wired charging method and a wireless charging method. The charger IC may charge a battery and prevent over voltage or over current from a charger. According to an embodiment, the charger IC may include a charger IC for at least one of the wired charging or the wireless charging. Examples of the wireless charging may include magnetic resonance charging, magnetic induction charging, and electromagnetic charging, and an additional circuit such as a coil loop, a resonance circuit, and a rectifier may be added for the wireless charging.

The battery gauge may measure, for example, a remaining quantity of the battery 296, or a voltage, a current, or a temperature during the charging. The battery 296 may store or generate electricity, and may supply power to the electronic device 201 using the stored or generated electricity. The battery 296 may include, for example, a rechargeable battery or a solar battery.

The indicator 297 may display a specific status of the electronic device 201 or the part (for example, the AP 210) of electronic device 201, for example, a booting status, a message status, a charging status, and the like. The motor 298 may convert an electrical signal to a mechanical vibration. Although not illustrated, the electronic device 201 may include a processing unit (for example, a GPU) for supporting mobile TV. The processing unit for supporting mobile TV may process media data according to a standard of Digital Multimedia Broadcasting (DMB), Digital Video Broadcasting (DVB), media flow or the like.

Each of the components of the electronic device according to the present disclosure may be implemented by one or more components and the name of the corresponding component may vary depending on a type of the electronic device. The electronic device according to the present disclosure may be configured by including at least one of the above-described elements, and some of the elements may be omitted, or other elements may be added. Further, some of the elements of the electronic device according to the present disclosure may be combined to be one entity, which can perform the same functions as those of the elements before the combination.

The term “module” used in the present disclosure may refer to, for example, a unit including one or more combinations of hardware, software, and firmware. The “module” may be interchangeable with a term, such as a unit, a logic, a logical block, a component, or a circuit. The “module” may be the smallest unit of an integrated component or a part thereof. The “module” may be the smallest unit that performs one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), or a programmable-logic device for performing operations which has been known or are to be developed hereinafter.

According to various embodiments of the present disclosure, an electronic device may include: a display; and a processor for identifying a current position of the electronic device, detecting one or more preset electronic devices based on the position, and displaying the one or more electronic devices.

According to an embodiment, the electronic device may further include a memory configured to store identification information of the one or more electronic devices and a communication module configured to communicate with a server. The processor may select the one or more electronic devices and transmit the identification information to the server.

According to an embodiment, the processor may transmit the position to the server.

According to an embodiment, the processor may receive and detect the identification information of the one or more electronic devices from the server.

According to an embodiment, the server may include a communication unit configured to communicate with the electronic device; and a controller configured to perform a configuration by mapping the electronic device and the one or more electronic devices, and, when the one or more electronic devices are located within a preset range from the electronic device, transmit the identification information of the one or more electronic device to the electronic device by the server.

According to an embodiment, the controller may receive the identification information of the one or more electronic devices from the electronic device and configure the identification information of the one or more electronic devices based on the electronic device.

According to an embodiment, the controller may receive the position of the electronic device and positions of the one or more electronic devices and determine whether the one or more electronic devices are located within the preset range from the electronic device.

According to an embodiment, when the electronic device and the one or more electronic devices are located within coverage of an equal Base Station (BS), the one or more electronic devices may be detected.

According to an embodiment, when positions of the one or more electronic devices are within a preset distance from the position of the electronic device, the one or more electronic device may be detected.

According to an embodiment, the processor may identify the position when a preset application is executed.

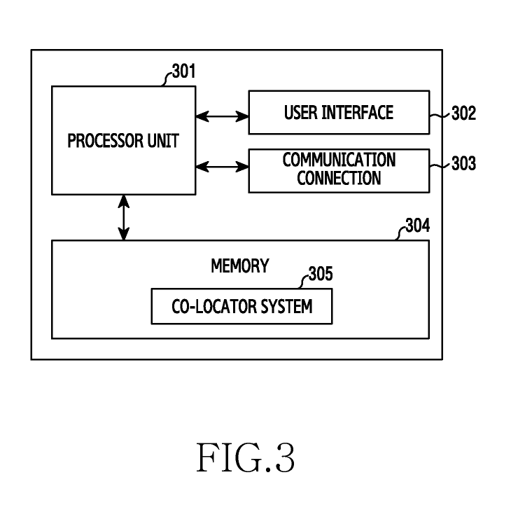

FIG. 3 is a general block diagram of an electronic device according to various embodiments. An electronic device 300 according to various embodiments of the present disclosure may include a processor unit 301, a user interface 302, a communication connection 303, a memory 304, and a co-locator system 305.

The processor unit 301 of the electronic device 300 may control a general operation of the electronic device 300. For example, the processor unit 301 may configure publication configuration information for identification information selected by the user. For example, the identification information may be a contact. Further, the processor unit 301 may identify that situation information is configured to be shared with another electronic device that uses the selected identification information. In addition, the processor unit 301 may identify that a list of the selected identification information includes an area for configuring the publication configuration information, and identify that situation information is configured to be shared with another electronic device that uses the identification information included in the list of the identification information. Furthermore, the processor unit 301 may determine whether at least one piece of publication configuration information or position information changes on a preset cycle.

The user interface 302 of the electronic device 300 may receive an input for execution of an application for configuring the publication configuration information, display stored identification information, and receive a selection of at least one piece of the displayed identification information. Further, the user interface 302 may display one or more identification information lists including identification information of other electronic devices and receive a selection of one of the one or more displayed identification information lists. In addition, the user interface 302 may display information on one or more other electronic devices located within a preset range.

The communication connection 303 of the electronic device 300 may transmit the configured publication configuration information and position information to the server, and receive situation information of one or more other electronic devices located with a predetermined range from the server. Further, when it is determined that at least one piece of the publication configuration information or the position information is changed, the communication connection 303 may transmit the changed information to the server.

The memory 304 of the electronic device 300 may store data controlled by the processor unit 301.

The co-locator system 305 may process Global Positioning System (GPS) information of the electronic device 300, Access Point (AP) information, cell identification (ID) information, and Bluetooth information and transmit the processed information on a predetermined period. Further, the co-locator system 305 may configure identification information of an electronic device, with which the co-locator system 305 will share situation information, among the identification information stored in the address book, and configure whether to share the situation information with the electronic device having the identification information.

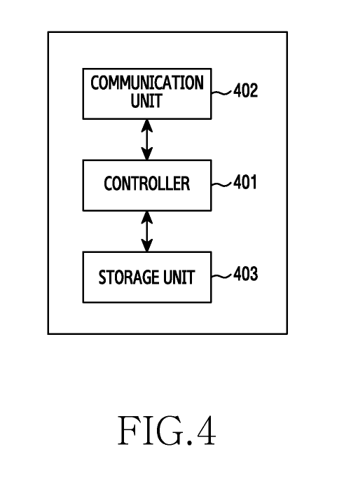

FIG. 4 is a block diagram illustrating a configuration of a server according to various embodiments. A server 400 according to various embodiments of the present disclosure may include a controller 401, a communication unit 402, and a storage unit 403.

The controller 401 of the server 400 controls a general operation of the server 400. For example, the controller 401 may analyze at least one piece of received publication configuration information and position information. Further, the controller 401 may search for two or more electronic devices configured to share situation information by analyzing the publication configuration information, analyze each piece of position information of the two or more found electronic devices, and calculate positions of the two or more found electronic devices. In addition, the controller 401 may determine whether the changed publication configuration information and the changed position information are received from one or more electronic devices. When it is determined that the pieces of information are received, the controller 401 may analyze at least one piece of the received publication configuration information or the position information.

The communication unit 402 of the server 400 processes a signal transmitted/received for voice and data communication. For example, when the communication unit 402 receives at least one piece of publication configuration information or position information from one or more electronic devices and the one or more electronic devices are located within a preset range, the communication unit 402 may transmit situation information to each of the electronic devices within the preset range.

The storage unit 403 of the server 400 may include a program storage unit, which stores a program for controlling an operation of the server 400, and a data storage unit, which stores data created while the program is executed.

In the aforementioned block configuration, the controller 401 may perform a general function of the server 400. A reason why the components are illustrated as separated blocks in various embodiments is to distinguish between and describe functions thereof. Accordingly, when the product is actually implemented, the product may be configured to process all or some of the functions of the server 400 by the controller 401.

When the server 400 receives at least one piece of publication configuration information or position information from one or more electronic devices and the one or more electronic devices are located with a preset range, the server 400 may include a communication unit for transmitting situation information to each of the electronic devices located within the preset range and a controller for analyzing at least one piece of the received publication configuration information or position information.

The controller 401 may search for two or more electronic devices configured to share situation information by analyzing the publication configuration information, analyze each piece of position information of the two or more found electronic devices, and calculate positions of the two or more found electronic devices.

The controller 401 may determine whether the changed publication configuration information and the changed position information are received from the one or more electronic devices. When it is determined that the pieces of information are received, the controller 401 may analyze at least one piece of the received publication configuration information or position information. When the one or more electronic devices are located with a preset range, the communication unit 402 may transmit situation information to each of the electronic devices located within the preset range.

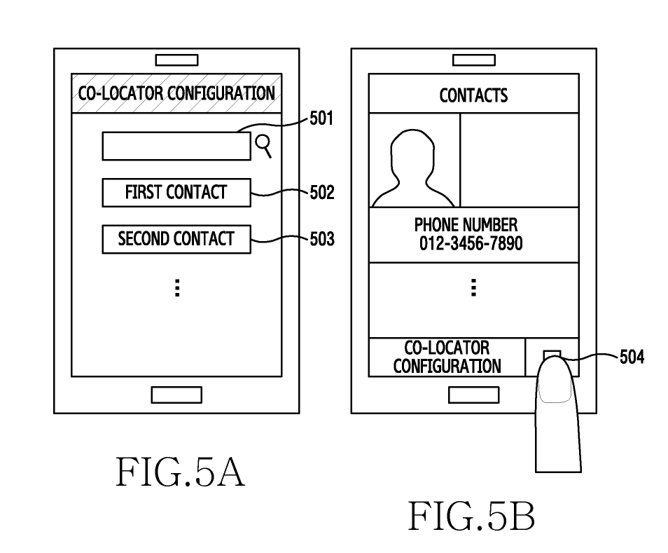

FIG. 5A and FIG. 5B illustrate a view for configuring publication configuration information according to various embodiments. The electronic device according to various embodiments of the present disclosure may configure publication configuration information for a contact selected by the user. The publication configuration information may be information configured to share situation information with another electronic device, which includes a contact selected by the user from among a plurality of contacts stored in the electronic device. For example, when the user selects a “contact A” from the contacts stored in the electronic device, the electronic device may share situation information with another electronic device having the “contact A” selected by the user.

The situation information may be information indicating that one or more other electronic devices are located within a preset range. For example, when a user of an “electronic device A” configures publication configuration information in the “electronic device A,” and a user of an “electronic device B” configures publication configuration information in the “electronic device B”, the publication configuration information may indicate situation information is to be shared between the two, which will be described further below. In the aforementioned example, when both the “electronic device A” and the “electronic device B” are located within a preset range, each of the “electronic device A” and the “electronic device B” may receive situation information indicating that the “electronic device A” and the “electronic device B” are located together within the preset range. Hereinafter, an embodiment in which a user configures situation information in an electronic device will be described in more detail.

FIG. 5A illustrates a first embodiment in which the electronic device receives a configuration of situation information according to various embodiments of the present disclosure. First, the electronic device may receive an input for execution of an application which may configure publication configuration information and display stored contacts. For example, a case where the application which may configure the publication configuration information in the electronic device as illustrated in FIG. 5A corresponds to an “application A” will be described. In the aforementioned example, the electronic device may receive an input for execution of the “application A” and display a plurality of contacts stored in the electronic device on a display of the electronic device.

Thereafter, the electronic device may receive a selection of at least one of the displayed contacts. For example, as illustrated in FIG. 5A, the electronic device may receive the selection of one or more contacts between contacts 502 and 503 displayed on the display of the electronic device, based on a user input. In another example, the electronic device may display, on the display of the electronic device, a contact input through a search box 501 displayed on the display of the electronic device, and receive a selection of the displayed contact by a user.

Thereafter, the electronic device may identify that situation information is configured to be shared with another electronic device that has the selected contact. For example, when the electronic device receives the selection of the first contact 502 and the second contact 503 based on a user input as illustrated in FIG. 5A, the electronic device may identify that situation information is configured to be shared with other electronic devices that have the first contact 502 and the second contact 503.

FIG. 5B illustrates a second embodiment in which the electronic device receives a configuration of situation information according to various embodiments of the present disclosure. First, the electronic device may display one or more contact lists including contact information of other electronic devices.

Thereafter, the electronic device may receive the selection of one of the one or more displayed contact lists. For example, as illustrated in FIG. 5B, the electronic device may receive the selection of a contact list that uses a phone number of “012-3456-7890” from a plurality of contact lists displayed on the electronic device.

Thereafter, the electronic device may identify that an area for configuring publication configuration information is included in the selected contact list. For example, as illustrated in FIG. 5B, the electronic device may identify that an area 504 for configuring publication configuration information, which is indicated by “co-locator configuration” is included in the contact list selected by the user.

Thereafter, the electronic device may receive the selection of the area 504 for configuring the publication configuration information and may identify that situation information is configured to be shared with another electronic device that has a contact included in the contact list. For example, when the electronic device receives the selection of the area for configuring the publication configuration information by the user as illustrated in FIG. 5B, the electronic device may identify that the situation information is configured to be shared with the electronic device having the phone number “012-3456-7890”.

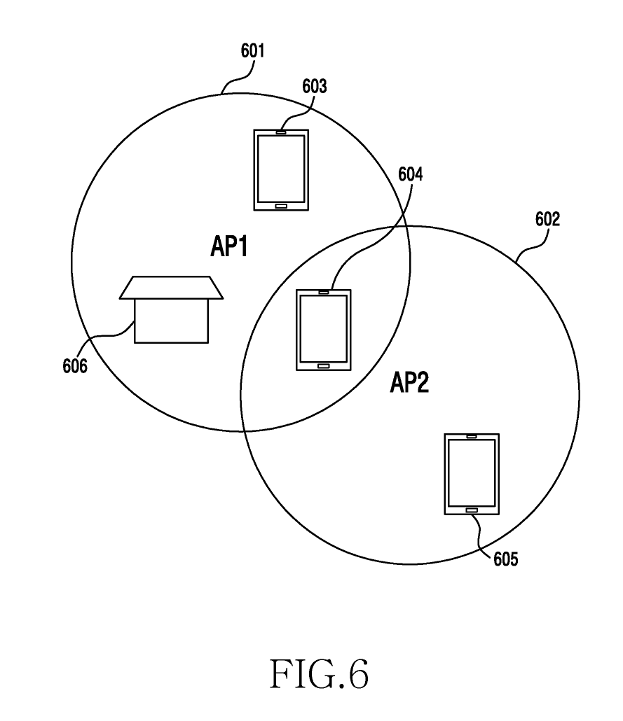

FIG. 6 illustrates searching for an adjacently located AP and recognizing another user located within a preset range, according to various embodiments. First, the electronic device may transmit publication configuration information and position information to the server in order to receive situation information from the server. The position information may include at least one piece of Global Positioning System (GPS) information of the electronic device, Access Point (AP) information, or cell Identification (ID) information. That is, the electronic device may transmit the publication configuration information configured by the user's selection and the position information of the electronic device to the server.

For example, a case where a first electronic device 603 configures contacts of a second electronic device 604 and a third electronic device 605 as contacts for the publication configuration as illustrated in FIG. 6 will be described. Further, a case where the second electronic device 604 also configures contacts of the first electronic device 603 as contacts for the publication configuration and the third electronic device 605 and the third electronic device 605 also configures contacts of the first electronic device 603 and the second electronic device 604 as contacts for the publication configuration will be described.

In the aforementioned example, the first electronic device 603, the second electronic device 604, and the third electronic device 605 may transmit publication configuration information and position information of the first electronic device 603, the second electronic device 604, and the third electronic device 605 to the server. For example, the first electronic device 603 may transmit a phone number of the second electronic device 604 and a phone number of the third electronic device 605 which correspond to the publication configuration information to the server together with at least one piece of GPS coordinate information of the first electronic device 603, AP information, or cell ID information.

Thereafter, the electronic device may receive situation information from the server. Specifically, the electronic device may receive situation information indicating whether another electronic device is located within a preset range from the server. For example, since the second electronic device 604 and the third electronic device 605 are located within an area 602 managed by AP2 as illustrated in FIG. 6, the second electronic device 604 may receive situation information indicating that the third electronic device 605 is located within a preset area from the server.

For example, a case where a user of the first electronic device 603 selects particular friends from contacts of friends stored in the first electronic device 603 and configures situation information to be shared with the friends after a morning class will be described. Further, a case where the second electronic device 604 and the third electronic device 605 also configure to share situation information with the first electronic device 603 will be described.

In the aforementioned example, the first electronic device 603 may receive situation information indicating that the second electronic device is located within a preset range 601. Accordingly, a user of the first electronic device 603 may easily make a lunch engagement with a user of the second electronic device 604 by transmitting a call to the second electronic device 604.

In another example, a case where the user of the first electronic device 603 stores a contact of a coffee shop 606 in the first electronic device 603 and the coffee shop 606 includes infrastructure configured to transmit a discount coupon to an electronic device within a preset range from the coffee shop 606 (e.g., which may be implemented through WiFi, and will be described as an example).

In the aforementioned example, when the first electronic device 603 is located within a preset range from the coffee shop 606, the first electronic device 603 may receive a discount coupon which can subsequently be used in the coffee shop 606.

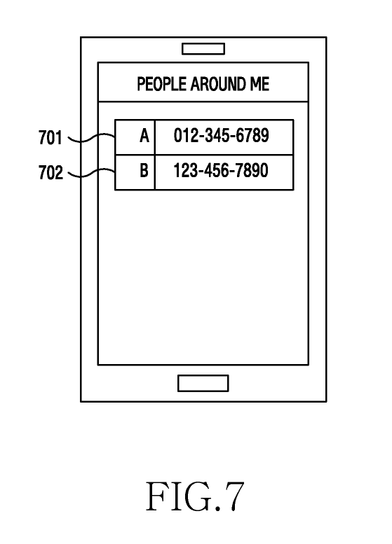

FIG. 7 is a view illustrating a screen on which the electronic device receives situation information from the server according to various embodiments. First, when the electronic device transmits publication configuration information and position information to the server, the electronic device may receive situation information from the server. Thereafter, the electronic device may display the situation information received from the server on a display of the electronic device. For example, as illustrated in FIG. 7, the electronic device may display situation information indicating that contact “A” 701 having a contact number of 012-345-6789″ and contact “B” 702 having a contact number of “123-456-7890” are located within a preset range on the display of the electronic device.

For example, a case where the user of the electronic device is scheduled to have a meeting in an “area C” in the evening will be described. In the aforementioned example, since the user of the electronic device may select contacts of other users who participate in the today meeting as publication configuration contacts, the user of the electronic device may not expose his/her own position information to other users.

In another embodiment, the electronic device determines whether at least one piece of publication configuration information or position information is changed on a predetermined period. When it is determined that at least one piece of publication configuration information or position information is changed, the electronic device may transmit the changed information to the server. That is, in order to provide accurate situation information which is changed in real time to the user, the electronic device may update publication configuration information and position information on a predetermined period.

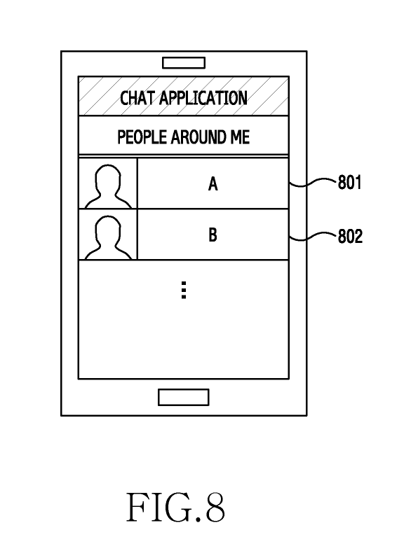

FIG. 8 is a view illustrating a screen for receiving situation information while interworking with a chat application according to various embodiments. First, the electronic device may also display situation information in another application installed in the electronic device. For example, when the electronic device executes the chat application as illustrated in FIG. 8, the electronic device may also display situation information in a predetermined area of a main screen of the chat application or a chat box.

For example, a case where the electronic device transmits publication configuration information and position information configured by the user to the server and receives execution of the chat application will be described.

In the aforementioned example, the electronic device may also display situation information indicating other users are located in a predetermined area of the main screen of the chat application or the chat box. For example, the electronic device may display situation information of “people around me” in a predetermined area of the chat application to inform the user of the electronic device of information indicating that a user “A” 801 and a user “B” 802 are located within a preset range.

Accordingly, the user of the electronic device may identify easy interworking with the conventional application such as the chat application while not exposing a position of the user to people who have other contacts stored in the electronic device.

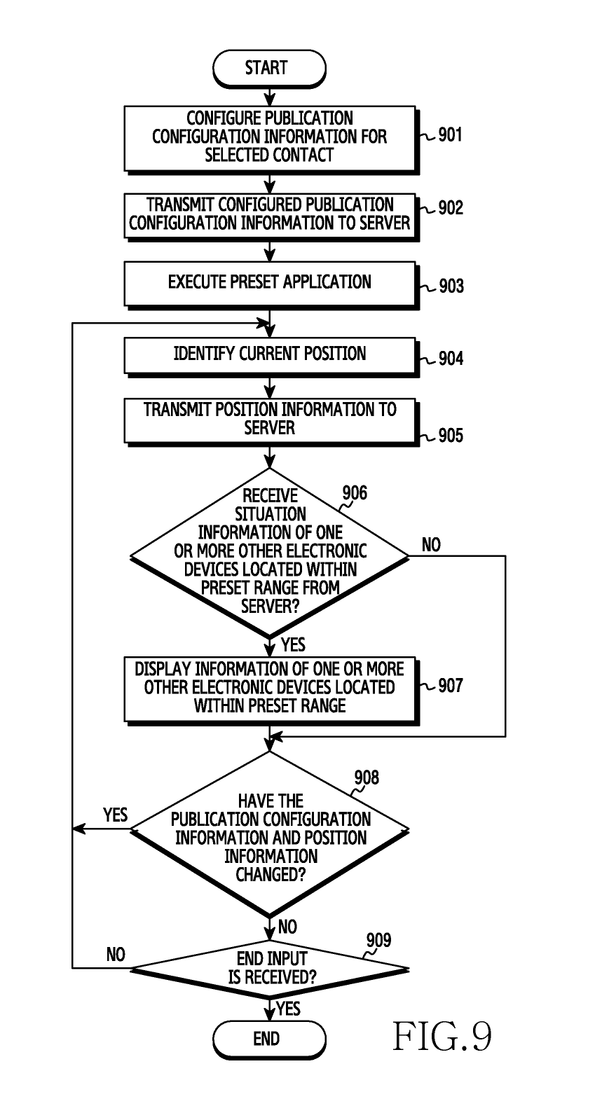

FIG. 9 is a flowchart illustrating a sequence of an operation of the electronic device according to various embodiments. In operation 901, the electronic device may configure publication configuration information for a selected contact. The publication configuration information may be information configured to share situation information with another electronic device, which has a contact selected by the user among contacts stored in the electronic device. For example, when the user selects a “contact A” from the contacts stored in the electronic device, the electronic device may share situation information with another electronic device corresponding to the “contact A” selected by the user.

In operation 902, the electronic device may transmit the configured publication configuration information to the server.

In operation 903, the electronic device may execute a preset application. For example, the preset application may be a chat application.

In operation 904, the electronic device may identify a current position. The electronic device may identify the current position from a signal received from a GPS satellite. For example, the electronic device may identify the current position through GPS information. Alternatively, the electronic device may identify the current position from a currently accessed Base Station or “BS.” For example, the electronic device may identify AP information or cell ID information as the current position.

In operation 905, the electronic device may transmit the position information to the server. To this end, the electronic device may generate the position information corresponding to the current position. The position information may include at least one piece of GPS information of the electronic device, AP information, or cell ID information.

In operation 906, the electronic device may receive situation information of one or more other electronic devices located within a preset range from the server. The situation information may be information indicating that one or more other electronic devices are located within a preset range. For example, when a user of an “electronic device A” configures publication configuration information in the “electronic device A” and a user of an “electronic device B” configures publication configuration information in the “electronic device B,” the publication configuration information may indicate intended sharing of information between the two, which will be described below. In the aforementioned example, when both the “electronic device A” and the “electronic device B” are located within a preset range, each of the “electronic device A” and the “electronic device B” may receive situation information indicating that the other device is located within the preset range.

Thus, if the situation information is received indicating one or more other electronic devices are within the preset range, then in operation 907, the electronic device may display information on one or more other electronic devices located within a preset range. For example, the electronic device may display situation information indicating that both the “electronic device A” and the “electronic device B” are located within the preset range on the display of the electronic device. If this information is not received, then the operation may proceed directly to operation 908 without operation 907.

In operation 908, the electronic device may determine whether publication configuration information and position information have changed. That is, the electronic device may determine whether the user has newly configured publication configuration information and determine whether position information has changed according to movement of the electronic device.

In operation 909, when it is determined that the publication configuration information and the position information have not changed, the electronic device may determine whether the electronic device receives an input for the end. That is, when the electronic device determines whether the input for ending the situation information displayed on the display is received and determines that the input for the end is received, the electronic device may end the sequence of the operation.

When the electronic device determines that the publication configuration information and the position information have changed in operation 908, the electronic device may determine return to operation 904.

When the electronic device does not receive the input for ending the displaying of the situation information based on a user input in operation 909, the electronic device may return to operation 904. When the end input is received, the operations may end.

According to various embodiments of the present disclosure, a method of operating an electronic device may include: identifying a current position of the electronic device; detecting one or more preset electronic devices based on the position; and displaying the one or more electronic devices.

According to an embodiment, the method may further include: selecting the one or more electronic devices based on pre-stored identification information of the one or more electronic devices; and transmitting the identification information to a server.

According to an embodiment, the method may further include transmitting the position to the server.

According to an embodiment, the detecting of the one or more electronic devices may include receiving the identification information of the one or more electronic devices from the server.

According to an embodiment, the method may further include: performing a configuration by mapping the electronic device and the one or more electronic devices by the server; and, when the one or more electronic devices are located within a preset range from the electronic device, transmitting the identification information of the one or more electronic device to the electronic device by the server.

According to an embodiment, the performing of the configuration may include receiving the identification information of the one or more electronic devices from the electronic device and configuring the identification information of the one or more electronic devices based on the electronic device.

According to an embodiment, the method may further include: receiving the position of the electronic device and positions of the one or more electronic devices by the server; and determining whether the one or more electronic devices are located within the preset range from the electronic device by the server.

According to an embodiment, when the electronic device and the one or more electronic devices are located within coverage of an equal Base Station (BS), the one or more electronic devices may be detected.

According to an embodiment, when positions of the one or more electronic devices are within a preset distance from the position of the electronic device, the one or more electronic device may be detected.

According to an embodiment, the identifying of the current position may be performed when a preset application is executed.

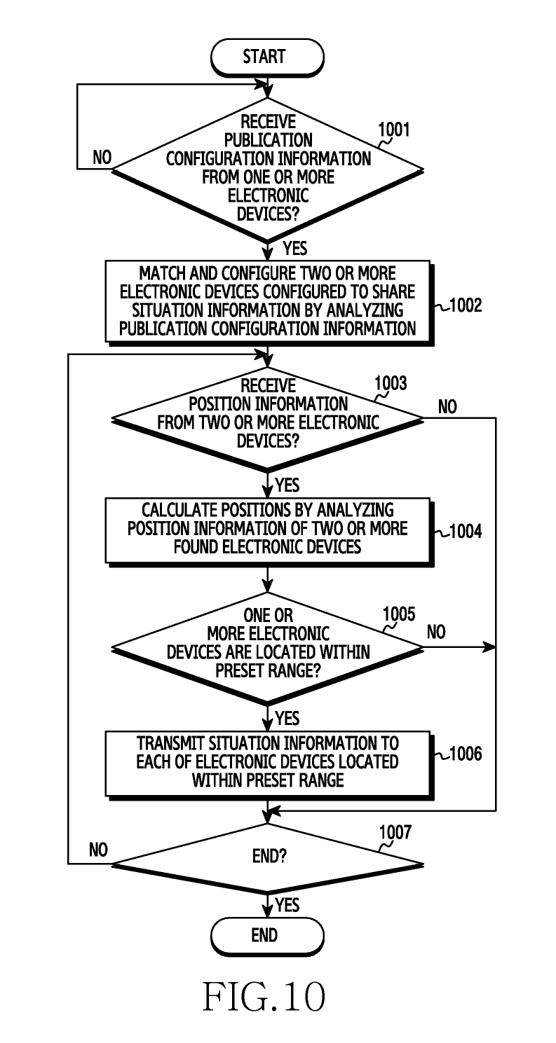

FIG. 10 is a flowchart illustrating a sequence of an operation of the server according to various embodiments. In operation 1001, the server may receive publication configuration information from one or more electronic devices. For example, the server may receive publication configuration information including one or more contacts, indicating an intent to receive situation information from each of a first electronic device to an N^{th} electronic device.

In operation 1002, the server may match and configure two or more electronic devices. The server may search for two or more electronic devices configured to share situation information by analyzing received publication configuration information. For example, the server may configure the first and second electronic devices such that the first and second electronic devices are to share situation information by analyzing the publication configuration information received from each of the first and second electronic devices.

In operation 1003, the server may receive position information of the electronic devices. If so, it may proceed to operation 1004. If not, the server may recheck whether position information has been received.

In operation 1004, the server may calculate respective positions of each of the electronic devices by analyzing position information of the two or more found electronic devices. For example, the server may identify positions of the first electronic device and the second electronic device by analyzing AP information of the first electronic device and the second electronic device, which are configured to share situation information.

In operation 1005, the server may determine whether one or more electronic devices are located within a preset range. For example, the server may determine whether the first electronic device and the second electronic device are located within the coverage of the same BS. To this end, the server may compare AP information or cell ID information of the first electronic device and the second electronic device. Alternatively, the server may determine whether the first electronic device and the second electronic device are located within a preset distance from each other. If one or more devices are located within the preset range, the operations may proceed to operation 1006. If not, the operations may return to operation 1003.

In operation 1006, when the server determines that the one or more electronic devices are located within the preset range, the server may transmit situation information to each of the electronic devices located within the preset range. For example, when the server determines that the first electronic device and the second electronic device are located within the preset range, the server may transmit situation information indicating that the second electronic device is located within the preset range to the first electronic device. Further, the server may transmit situation information indicating that the first electronic device is located within the preset range to the second electronic device.

In operation 1007, the server may determine whether to end the sequence of the operation. In one alternative embodiment, when the server determines to end the sequence of the operation, the server may end the sequence of the operation.

In one alternative embodiment, in operation 1005, when the server determines that the one or more electronic devices are not located within the preset range, the server may proceed operation 1007.

In one alternative embodiment, in operation 1007, when the server determines that the changed publication information and the changed position information are received, the server may repeat operation 1003.

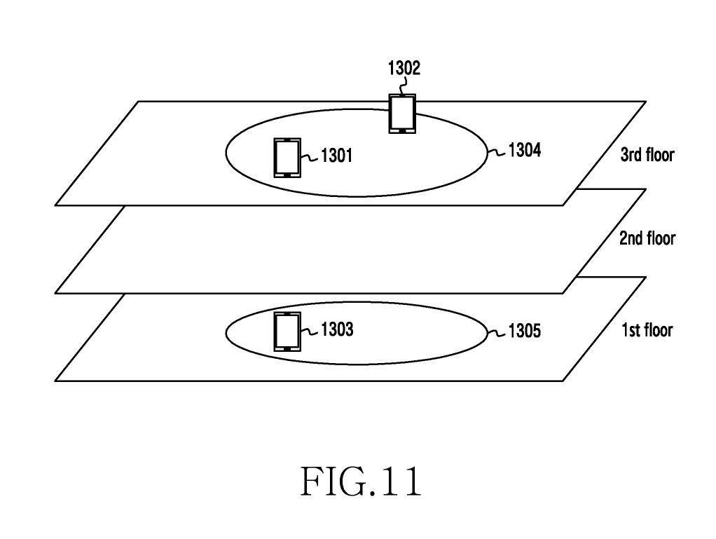

FIG. 11 is a view illustrating reception of situation information by using AP information according to various embodiments of the present disclosure. According to various embodiments, the electronic device may transmit publication configuration information and position information to the server in order to receive situation information from the server. Hereinafter, a case where position information in a first electronic device 1301 is configured by GPS information, a second electronic device 1302, and a third electronic device 1303 and the first electronic device 1301 is configured to share information with contacts of the second electronic device 1302 and the third electronic device 1303 will be described. Further, a case where the second electronic device 1302 is also configured to share information with contacts of the first electronic device 1301 and the third electronic device 1303 and the third electronic device 1303 is also configured to share information with contacts of the first electronic device 1301 and the second electronic device 1302 will be described.

According to various embodiments, the first electronic device 1301, the second electronic device 1302, and the third electronic device 1303 may each transmit publication configuration information and position information of the electronic devices 1301, 1302, and 1303 to the server, respectively. According to an embodiment, the first electronic device 1301 may transmit a phone number of the second electronic device 1302 and a phone number of the third electronic device 1303, which correspond to publication configuration information, to the server together with GPS information of the first electronic device 1301.

According to various embodiments, the first electronic device 1301 may determine whether a battery capacity of the first electronic device 1301 is equal to or smaller than a preset capacity. According to an embodiment, when the battery capacity of the first electronic device 1301 is configured as 30%, the first electronic device 1301 may determine whether a current battery capacity of the first electronic device 1301 is equal to or smaller than 30%.

According to various embodiments, when the first electronic device 1301 determines that the battery capacity is equal to or smaller than the preset battery capacity, the first electronic device 1301 may determine whether information configured as the position information is configured as the GPS information. In the aforementioned example, since the position information of the first electronic device 1301 is configured as the GPS information, the first electronic device 1301 may identify that the position information is configured as the GPS information.

According to various embodiments, the first electronic device 1301 may switch the position information configured as the GPS information to AP information. According to an embodiment, if the position information is configured as the GPS information in the first electronic device 1301, battery consumption of the first electronic device 1301 increases, so the first electronic device 1301 may switch the position information configured as the GPS information to the AP information. According to an embodiment, the first electronic device 1301 may receive situation information indicating that the first electronic device 1301 and the second electronic device 1302 are located within the same AP coverage 1304 from the server.

According to various embodiments, the first electronic device 1301 may receive situation information from the server by using the AP information, so that the first electronic device 1301 can receive more accurate situation information compared to the other electronic devices 1302 and 1303. According to an embodiment, the first electronic device 1301 may refer to a database including all information related to positions of the second electronic device 1302 and the third electronic device 1303 from a server linked with the first electronic device 1301. For example, the first electronic device 1301 may identify information indicating that the second electronic device 1302 is currently located on the third floor and the third electronic device is currently located on the first floor by using the database referred to from the server.

According to various embodiments, when the first electronic device 1301 switches the position information configured as the GPS information to the AP information in consideration of battery consumption, the first electronic device 1301 may receive accurate situation information of the other electronic devices 1302 and 1303 while reducing battery consumption. According to an embodiment, when the first electronic device 1301 switches the position information configured as the GPS information to the AP information in consideration of battery consumption, the first electronic device 1301 may identify that the third electronic device 1303 is located within an AP coverage 1305 different from that of the first electronic device 1301.

According to various embodiments, when the position information is configured as the GPS information in the first electronic device 1301, the first electronic device 1301 may manually switch the position information configured as the GPS information to the AP information according to a user input with no regard to a current battery capacity of the first electronic device 1301.

According to various embodiments, the first electronic device 1301 may determine whether the position information is configured as the GPS information with no regard to the current battery capacity of the first electronic device 1301. According to various embodiments, when the position information is not configured as the GPS information, the first electronic device 1301 may determine whether the position information is configured as the AP information. According to various embodiments, when the position information is not configured as the AP information, the first electronic device 1301 may switch the position information to cell ID information (e.g., an identifying cell for cellular communication). Even though the position information is not linked to the GPS information, the electronic device according to the present disclosure may provide position information of another electronic device through AP information or cell ID information.

Meanwhile, the example embodiments disclosed in the specification and drawings are merely presented to easily describe the technical contents of the present disclosure and help with the understanding of the present disclosure and are not intended to limit the present disclosure. Therefore, all changes or modifications derived from the technical idea of the present disclosure as well as the embodiments described herein should be interpreted to belong to the present disclosure.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”. In addition, an artisan understands and appreciates that a “processor” or “microprocessor” may be hardware in the claimed disclosure. Under the broadest reasonable interpretation, the appended claims are statutory subject matter in compliance with 35 U.S.C. §101.

What is claimed is:

1. A method of operating an electronic device, the method comprising:
identifying a current position of the electronic device;
detecting one or more preset electronic devices based on the identified current position; and
displaying the one or more preset electronic devices.

2. The method of claim 1, further comprising:
selecting the one or more preset electronic devices based on pre-stored identification information stored on the electronic device; and
transmitting the identification information to a server.

3. The method of claim 2, further comprising transmitting the identified current position to the server.

4. The method of claim 2, wherein the detecting of the one or more preset electronic devices comprises receiving the identification information of the one or more preset electronic devices from the server.

5. The method of claim 4, wherein the server maps the electronic device and the one or more preset electronic devices, and when the one or more preset electronic devices are located within a preset range from the electronic device as detected by the server, transmits the identification information of the one or more preset electronic device to the electronic device.

6. The method of claim 5, wherein the server receives the identification information of the one or more preset electronic devices from the electronic device, and configures the identification information of the one or more preset electronic devices corresponding to the electron device.

7. The method of claim 6, wherein the server receives the identified current position of electronic device and positions of the one or more preset electronic devices, and determines whether the one or more preset electronic devices are located within the preset range from the electronic device.

8. The method of claim 1, wherein the one or more preset electronic devices are detected when the electronic device and the one or more preset electronic devices are located within coverage of an equal Base Station (BS).

9. The method of claim 1, wherein the one or more preset electronic devices are detected when respective positions of the one or more preset electronic devices are disposed within a threshold distance from the identified current position.

10. The method of claim 1, wherein the identifying of the current position is executed in response to detecting execution of a preset application.

11. An electronic device comprising:
a display; and
a processor configured to:
identify a current position of the electronic device,
detect one or more preset electronic devices based on the identified current position, and
displaying on the display the one or more preset electronic devices.

12. The electronic device of claim 11, further comprising:
a memory configured to store identification information of the one or more electronic devices; and
a communication module configured to communicate with a server,
wherein the processor is further configured to select the one or more preset electronic devices and transmits the identification information to the server.

13. The electronic device of claim 12, wherein the processor is further configured to transmit the identified current position to the server.

14. The electronic device of claim 12, wherein the processor is further configured to receive the identification information of the one or more preset electronic devices from the server.

15. The electronic device of claim 14, wherein the server maps the electronic device and the one or more preset electronic devices, and when the one or more preset electronic devices are located within a preset range from the electronic device as detected by the server, transmits the identification information of the one or more preset electronic device to the electronic device.

16. The electronic device of claim 15, wherein the server receives the identification information of the one or more preset electronic devices from the electronic device, and configures the identification information of the one or more preset electronic devices corresponding to the electron device.

17. The electronic device of claim 16, wherein the server receives the identified current position of electronic device and positions of the one or more preset electronic devices, and determines whether the one or more preset electronic devices are located within the preset range from the electronic device.

18. The electronic device of claim 11, wherein the one or more preset electronic devices are detected when the electronic device and the one or more preset electronic devices are located within coverage of an equal Base Station (BS).

19. The electronic device of claim 11, wherein the one or more preset electronic devices are detected when respective positions of the one or more preset electronic devices are disposed within a threshold distance from the identified current position.

20. The electronic device of claim 11, wherein identifying the current position is executed in response to execution of a preset application.
